(19) United States
(12) Patent Application Publication
(10) Pub. No.: US 2015/0282135 A1
(43) Pub. Date: Oct. 1, 2015

(54) METHOD AND APPARATUS FOR DETERMINING SEARCH SPACE OF E-PDCCH OF UE

(71) Applicants: Qi Jiang, Shanghai (CN); Zheng Liu, Shanghai (CN); Matthew Baker, Canterbury (GB); Shin Horng Wong, Chippenham (GB)

(72) Inventors: Qi Jiang, Shanghai (CN); Zheng Liu, Shanghai (CN); Matthew Baker, Canterbury (GB); Shin Horng Wong, Chippenham (GB)

(73) Assignee: ALCATEL LUCENT, Boulogne Billancourt (FR)

(21) Appl. No.: 14/440,677

(22) PCT Filed: Oct. 14, 2013
(86) PCT No.: PCT/IB2013/002463

§ 371 Date: May 5, 2015

(30) Foreign Application Priority Data
Nov. 5, 2012 (CN) 201210437130.2

(51) Int. Cl. H04W 72/04

(52) U.S. Cl. CPC H04W 72/042

(57) ABSTRACT

The invention discloses a method and an apparatus for determining a search space of an E-PDCCH of a user equipment. According to the invention, first it is determined a distance between candidates of a search space per aggregation level; and then it is determined a position of a corresponding candidate of the search space per aggregation level in allocated ECCEs at least according to the determined distance. With the invention, candidates of a search space per aggregation level can be positioned uniformly in allocated ECCEs.

### FIELD OF THE INVENTION

The present disclosure relates to the field of communications. More particularly the invention relates to a method and apparatus for determining a search space of an Enhanced Physical Downlink Control Channel (E-PDCCH) of a User Equipment (UE).

### BACKGROUND OF THE INVENTION

The design of an Enhanced Physical Downlink Control Channel (E-PDCCH) is considered as an effective method of improving the scheduling capacity of an LTE-A system.

The E-PDCCH is implemented on one or more Physical Resource Block (PRB) pairs of a sub-frame. Each PRB is a block of resource temporally including a time-domain resource occupied by half a timeslot in a sub-frame, that is, 7 OFDM symbols, or including in frequency a frequency-domain resource occupied by 12 sub-carriers, totaling to 180 kHz in the case of 15 kHz per sub-carrier. A PRB pair includes PRBs in two timeslots in a sub-frame.

The E-PDCCH is organized at the granularity of a resource unit of Enhanced Control Channel Element (ECCE). An ECCE can be composed of a plurality of (e.g., 4 or 8) Enhanced Resource Element Groups (EREGs). A PRB pair includes 16 EREGs.

The E-PDCCH can be centralized or distributed. In the case of being centralized, an ECCE is mapped to EREGs of the same PRB pair. In the case of being distributed, an ECCE is mapped to EREGs of different PRB pairs. In the case of being centralized, the multi-user gain can be obtained through scheduling in the frequency domain. In the case of being distributed, a gain of frequency diversity can be obtained.

At different aggregation levels, an E-PDCCH can include one or more ECCEs. There are aggregation levels 1, 2, 4 and 8, that is, the E-PDCCH can be consisted of 1 ECCE, 2 ECCEs, 4 ECCEs and 8 ECCEs.

At different ECCE aggregation levels, there are a corresponding number of candidates, that is, the largest number of blind detections in the same Downlink Control Indicator (DCI) format. For example, in a user-specific search space, there are 8 candidates at the aggregation level 1; there are 4 candidates at the aggregation level 2; there are 2 candidates at the aggregation level 4; and there is 1 candidate at the aggregation level 8.

In the prior art, candidates per ECCE aggregation level are allocated consecutively, which may be disadvantageous, for example, candidates may be allocated substantially on the same PRB pair for the centralized E-PDCCH.

### SUMMARY OF THE INVENTION

According to an aspect of the invention, there is proposed a method of determining a search space of an Enhanced Physical Downlink Control Channel, E-PDCCH, of a user equipment, the method including the steps of: determining a distance between candidates of a search space per aggregation level; and determining a position of a corresponding candidate of the search space per aggregation level in allocated Enhanced Control Channel Elements, ECCEs, at least according to the determined distance.

According to another aspect of the invention, there is proposed an apparatus for determining a search space of an Enhanced Physical Downlink Control Channel, E-PDCCH, of a user equipment, the apparatus including: a first determining unit configured to determine a distance between candidates of a search space per aggregation level; and a second determining unit configured to determine a position of a corresponding candidate of the search space per aggregation level in allocated Enhanced Control Channel Elements, ECCEs, at least according to the determined distance.

With the invention, candidates of a search space per aggregation level can be positioned uniformly in allocated ECCEs.

### BRIEF DESCRIPTION OF DRAWINGS

Other objects and effects of the invention will become more apparent and better appreciated from the following description in connection with the drawings and more comprehensive understanding of the invention. In the drawings:

FIG. 1 illustrates a wireless communication system in which the invention can be implemented;

FIG. 2 illustrates a flow chart of a method according to an embodiment of the invention;

FIG. 3 illustrates a flow chart of a method according to an embodiment of the invention;

FIG. 4 illustrates a flow chart of a method according to an embodiment of the invention;

FIG. 5 illustrates candidates of a search space determined according to an embodiment of the invention;

FIG. 6 illustrates a block diagram of an apparatus according to an embodiment of the invention;

FIG. 7 illustrates a block diagram of an apparatus according to an embodiment of the invention; and

FIG. 8 illustrates a block diagram of an apparatus according to an embodiment of the invention.

Identical reference numerals denote identical, similar or corresponding features or functions throughout the drawings.

### DETAILED DESCRIPTION OF EMBODIMENTS

Embodiments of the invention will be described below in details with reference to the drawings.

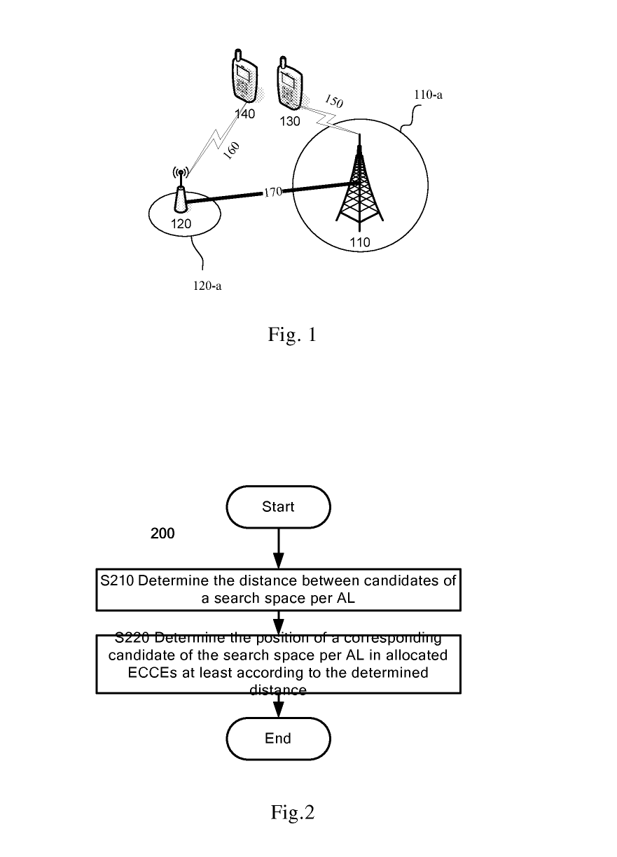

FIG. 1 illustrates a wireless communication system in which the invention can be implemented.

As illustrated in FIG. 1, the wireless communication system 100 includes a first base station 110 corresponding to a first cell, a second base station 120 corresponding to a second cell, and user equipments UE 130 and 140.

The first base station 110 provides a first coverage area 110-a, and the second base station 120 provides a second coverage area 120-a.

Assumed here the user equipment 130 is in the first coverage area 110-a. Thus the user equipment 130 communicates with the first base station 110 over a radio link 150. The user equipment 140 is in the second coverage area 120-a. Thus the user equipment 140 communicates with the second base station 120 over a radio link 160. Moreover the first base station 110 and the second base station 120 communicate over a backhaul link 170. The backhaul link 170 may be wired or wireless.

Assumed here the first base station 110 and the second base station 120 are evolved Node B (eNB).

Of course, those skilled in the art shall appreciate that the wireless communication system 100 can include a larger or smaller number of base stations, and each base station can serve a larger or smaller number of user equipments.

FIG. 2 illustrates a flow chart of a method according to an embodiment of the invention.

As illustrated in FIG. 2, the method 200 of determining a search space of an E-PDCCH of a user equipment includes the step S210 of determining the distance between candidates of a search space per aggregation level; and the step S220 of determining the position of a corresponding candidate of the search space per aggregation level in allocated ECCEs at least according to the determined distance.

The distances between respective adjacent candidates may or may not be the same. Moreover the distance between adjacent candidates may or may not be the same at different aggregation levels. Preferably the distance between respective adjacent candidates is the same, e.g., 2, at different aggregation levels, so that the candidates of the search space per aggregation level can be positioned uniformly in the allocated ECCEs.

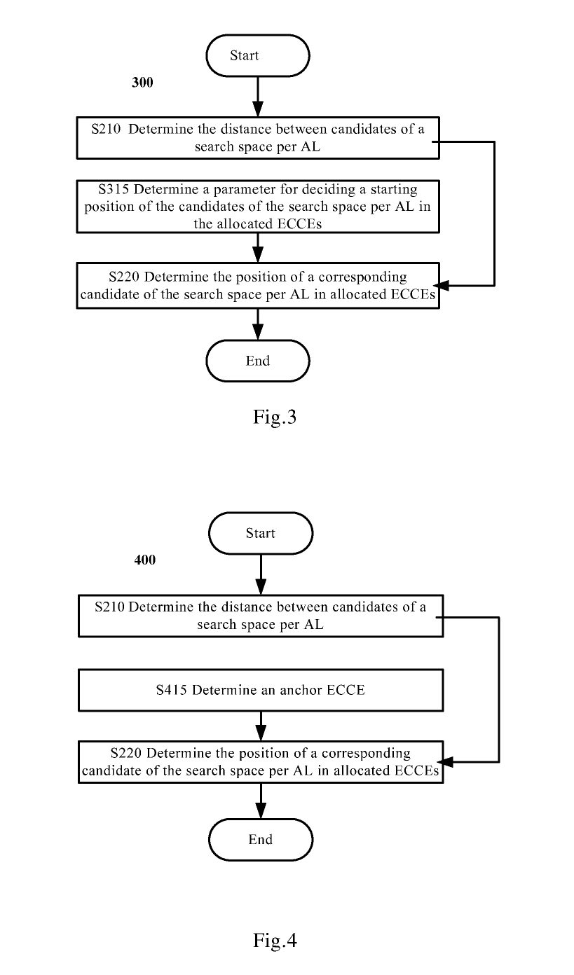

FIG. 3 illustrates a flow chart of a method according to an embodiment of the invention.

As compared with the method 200 illustrated in FIG. 2, the method 300 illustrated in FIG. 3 further includes the step S315 of determining a parameter for deciding a starting position of the candidates of the search space per aggregation level in the allocated ECCEs, and in the step S220, the position of the corresponding candidate of the search space per aggregation level in the allocated ECCEs is determined further according to the determined parameter.

In this embodiment, the starting positions of the candidates of the search space at different aggregation levels in the allocated ECCEs may be the same.

In an embodiment, the parameter is determined in the formula of:

$${O}_{L} • ⌈ \frac{{N}_{ECCE , k}}{L {•M}_{L}} ⌉ , \qquad ( 1 )$$

Where L represents an aggregation level, O_{L} represents the parameter at the L-th aggregation level, N_{ECCE, k} represents the total number of available ECCEs configured in the k-th sub-frame to be used for the user equipment, and M_{L} represents the total number of candidates of the search space at the L-th aggregation level.

Moreover in an embodiment, the distance is determined in the formula of:

$${P}_{L} • ⌊ \frac{{N}_{ECCE , k}}{L • {M}_{L}} ⌋ , \qquad ( 2 )$$

Where P_{L} represents the distance between the candidates at the L-th aggregation level.

In an embodiment, the position of the corresponding candidate of the search space per aggregation level in the allocated ECCEs is determined in the formula of:

Sₖ^{(L)}=L{(Yₖ+m·P_{L}+O_{L})mod └N_{ECCE,k}/L┘}+i, i=0, 1, 2, . . . L−1, (3) and

Yₖ=(A·Yₖ₋₁)mod D, (4)

Where Sₖ^{(L)} represents the search space at the L-th aggregation level, m=0, . . . , M_{L}−1 represents a serial number across the M_{L} candidates, i represents a serial number across the ECCEs per aggregation level, Yₖ represents a hash function of the k-th sub-frame, and A and D represent constants with A=39827 and D=65537. For different frames, the hash function may be different, and various known hash functions can be adopted. Since this aspect is less relevant to the invention, a further description thereof will be omitted here for the sake of clarity.

FIG. 4 illustrates a flow chart of a method according to an embodiment of the invention.

As compared with the method 200 illustrated in FIG. 2, the method 400 illustrated in FIG. 4 further includes the step S415 of determining an anchor ECCE, where the anchor ECCE is included throughout the candidates of the search space per aggregation level; and in the step S220, the position of the corresponding candidate of the search space per aggregation level in the allocated ECCEs is determined further according to the anchor ECCE.

In an embodiment, the position of the corresponding candidate of the search space per aggregation level in the allocated ECCEs is determined in the formula of:

$${S}_{k}^{( L )} = L \{ ( m \cdot {P}_{L} + ⌊ \frac{{I}_{ECCE , k}}{L} ⌋ ) mod ⌊ {N}_{ECCE , k} / L ⌋ \} + i , \\ i = 0 , 1 , 2 , … L - 1 , \qquad ( 5 )$$

### Where:

L represents an aggregation level, Sₖ^{(L)} represents the search space at the L-th aggregation level, m=0, . . . , M_{L}−1 represents a serial number across the M_{L} candidates, i represents a serial number across the ECCEs per aggregation level, M_{L} represents the total number of candidates of the search space at the L-th aggregation level, and N_{ECCE, k} represents the total number of available ECCEs configured in the k-th sub-frame to be used for the user equipment,

$${P}_{L} = ⌊ \frac{{N}_{ECCE , k}}{L \cdot {M}_{L}} ⌋ ,$$

represents the distance between the candidates at the L-th aggregation level,
I_{ECCE,k}=Yₖ mod(N_{ECCE,k}) represents an anchor ECCE of the k-th sub-frame, and
Y_{k=(A·Y}ₖ₋₁)mod D represents a hash function of the k-th sub-frame, and A and D represent constants with A=39827 and D=65537.

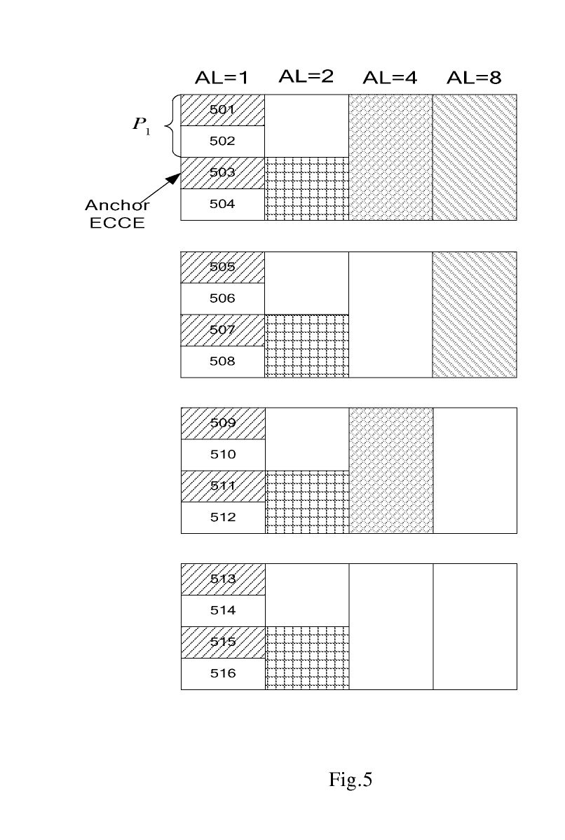

FIG. 5 illustrates the candidates of the search space determined according to the foregoing embodiments of the invention.

Particularly the distance between respective adjacent candidates is the same, i.e., 2, at each aggregation level. An ECCE indicated by the reference numeral 503 is an anchor ECCE.

More particularly, as indicated by hatching, the candidates of the search space at the aggregation level 1 include 8 ECCE with the reference numerals 501, 503, 505, 507, 509, 511, 513 and 515.

The candidates of the search space at the aggregation level 2 include 4 candidates, each of which is composed of two ECCEs, where the first candidate includes ECCEs with the reference numerals 503 and 504; the second candidate includes ECCEs with the reference numerals 507 and 508; the third candidate includes ECCEs with the reference numerals 511 and 512; and the first candidate includes ECCEs with the reference numerals 515 and 516.

The candidates of the search space at the aggregation level 4 include 2 candidates, each of which is composed of four ECCEs, where the first candidate includes ECCEs with the reference numerals 501, 502, 503 and 504; and the second candidate includes ECCEs with the reference numerals 509, 510, 511 and 512.

The candidates of the search space at the aggregation level 8 include 1 candidate composed of eight ECCEs, including ECCEs with the reference numerals 501, 502, 503, 504, 505, 506, 507 and 508.

It shall be noted that the foregoing respective embodiments are applicable to a centralized E-PDCCH and a distributed E-PDCCH.

Moreover it shall be further noted that the position is the index of an available ECCE configured to be used for the user equipment in the foregoing respective embodiments.

Moreover the method in the foregoing respective embodiments can be performed by a network-side device (e.g., an eNB) or a user-side device (e.g., a UE). The foregoing various parameters can be standard-specified and further stored in the network-side device or the user-side device or can be determined by a scheduler in a practical implementation process and further received from an external device.

At present the relevant 3GPP standard has specified mapping of ECCEs of a centralized E-PDCCH to EREGs but no mapping of ECCEs of a distributed E-PDCCH to EREGs.

In an embodiment of the invention, mapping of ECCEs of a distributed E-PDCCH to EREGs satisfies at least one of the following rules:

For an aggregation level above 1, in the case of aggregating adjacent ECCEs and in the case of multiplexing a centralized E-PDCCH and the distributed E-PDCCH on the same Physical Resource Block (PRB), a ratio of collision with an ECCE in the centralized E-PDCCH is minimized; and

When there are 8 PRB pairs of the distributed E-PDCCH and 4 EREGs per ECCE of the distributed E-PDCCH, EREGs corresponding to aggregated ECCEs are on all the PRB pairs for an aggregation level above 1 and with the presence of adjacent ECCEs.

More particularly:

With P>=N, where P represents the number of PRB pairs of the distributed E-PDCCH, and N represents the number of EREGs per ECCE,

An EREG n (n=0, . . . , N−1) in an ECCE j (j=0, . . . , N_{ECCE, k-1}) is given by an EREG q in a PRB pair p represented in the equations of:

$$\begin{matrix}p = j mod ( \frac{P}{N} ) + n \cdot \frac{P}{N} , \\ and & ( 6 ) \\ q = ( ⌊ \frac{j}{P / N} ⌋ mod N + ⌊ \frac{⌊ \frac{j}{P / N} ⌋}{N} ⌋ \cdot B + n \cdot B ) mod 16 ; & ( 7 )\end{matrix}$$

and

With P<N,

An EREG n (n=0, . . . , N−1) in an ECCE j (j=0, . . . , N_{ECCE, k-1}) is given by an EREG q in a PRB pair p represented in the equations of:

p=n mod P, (8) and

$$q = ( ⌊ \frac{j}{P} ⌋ + j mod P \cdot B + n \cdot B ) mod 16 , \qquad ( 9 )$$

Where N_{ECCE, k} represents the total number of available ECCEs configured in the k-th sub-frame to be used for the user equipment, and B represents the total number of ECCEs per PRB pair.

Table 1 to Table 6 depict mapping of ECCEs of a distributed E-PDCCH to EREGs derived according to the foregoing embodiment, where also mapping of ECCEs of a centralized E-PDCCH to EREGs as specified in the relevant 3GPP standard are depicted in Table 1 to Table 6 for comparison.

TABLE 1
ECCE/EREG mapping with P = 4 and N = 4

| ECCE | PRB pair index/EREG index in PRB pair | |
|---|---|---|
| Index | Centralized | Distributed |
| 0 | 0/0, 0/4, 0/8, 0/12 | 0/0, 1/4, 2/8, 3/12 |
| 1 | 0/1, 0/5, 0/9, 0/13 | 0/4, 1/8, 2/12, 3/0 |
| 2 | 0/2, 0/6, 0/10, 0/14 | 0/8, 1/12, 2/0, 3/4 |
| 3 | 0/3, 0/7, 0/11, 0/15 | 0/12, 1/0, 2/4, 3/8 |
| 4 | 1/0, 1/4, 1/8, 1/12 | 0/1, 1/5, 2/9, 3/13 |
| 5 | 1/1, 1/5, 1/9, 1/13 | 0/5, 1/9, 2/13, 3/1 |
| 6 | 1/2, 1/6, 1/10, 1/14 | 0/9, 1/13, 2/1, 3/5 |
| 7 | 1/3, 1/7, 1/11, 1/15 | 0/13, 1/1, 2/5, 3/9 |
| 8 | 2/0, 2/4, 2/8, 2/12 | 0/2, 1/6, 2/10, 3/14 |
| 9 | 2/1, 2/5, 2/9, 2/13 | 0/6, 1/10, 2/14, 3/2 |
| 10 | 2/2, 2/6, 2/10, 2/14 | 0/10, 1/14, 2/2, 3/6 |
| 11 | 2/3, 2/7, 2/11, 2/15 | 0/14, 1/2, 2/6, 3/10 |
| 12 | 3/0, 3/4, 3/8, 3/12 | 0/3, 1/7, 2/11, 3/15 |
| 13 | 3/1, 3/5, 3/9, 3/13 | 0/7, 1/11, 2/15, 3/3 |
| 14 | 3/2, 3/6, 3/10, 3/14 | 0/11, 1/15, 2/3, 3/7 |
| 15 | 3/3, 3/7, 3/11, 3/15 | 0/15, 1/3, 2/7, 3/11 |

TABLE 2
ECCE/EREG mapping with P = 8 and N = 8

| ECCE | PRB pair index/EREG index in PRB pair | |
|---|---|---|
| index | Centralized | Distributed |
| 0 | 0/0, 0/2, 0/4, 0/6, 0/8, | 0/0, 1/2, 2/4, 3/6, 4/8, |
| | 0/10, 0/12, 0/14 | 5/10, 6/12, 7/14 |
| 1 | 0/1, 0/3, 0/5, 0/7, 0/9, | 0/2, 1/4, 2/6, 3/8, 4/10, |
| | 0/11, 0/13, 0/15 | 5/12, 6/14, 7/0 |
| 2 | 1/0, 1/2, 1/4, 1/6, 1/8, | 0/4, 1/6, 2/8, 3/10, 4/12, |
| | 1/10, 1/12, 1/14 | 5/14, 6/0, 7/2 |
| 3 | 1/1, 1/3, 1/5, 1/7, 1/9, | 0/6, 1/8, 2/10, 3/12, 4/14, |
| | 1/11, 1/13, 1/15 | 5/0, 6/2, 7/4 |
| 4 | 2/0, 2/2, 2/4, 2/6, 2/8, | 0/8, 1/10, 2/12, 3/14, 4/0, |
| | 2/10, 2/12, 2/14 | 5/2, 6/4, 7/6 |
| 5 | 2/1, 2/3, 2/5, 2/7, 2/9, | 0/10, 1/12, 2/14, 3/0, 4/2, |
| | 2/11, 2/13, 2/15 | 5/4, 6/6, 7/8 |
| 6 | 3/0, 3/2, 3/4, 3/6, 3/8, | 0/12, 1/14, 2/0, 3/2, 4/4, |
| | 3/10, 3/12, 3/14 | 5/6, 6/8, 7/10 |
| 7 | 3/1, 3/3, 3/5, 3/7, 3/9, | 0/14, 1/0, 2/2, 3/4, 4/6, |
| | 3/11, 3/13, 3/15 | 5/8, 6/10, 7/12 |
| 8 | 4/0, 4/2, 4/4, 4/6, 4/8, | 0/1, 1/3, 2/5, 3/7, 4/9, |
| | 4/10, 4/12, 4/14 | 5/11, 6/13, 7/15 |
| 9 | 4/1, 4/3, 4/5, 4/7, 4/9, | 0/3, 1/5, 2/7, 3/9, 4/11, |
| | 4/11, 4/13, 4/15 | 5/13, 6/15, 7/1 |
| 10 | 5/0, 5/2, 5/4, 5/6, 5/8, | 0/5, 1/7, 2/9, 3/11, 4/13, |
| | 5/10, 5/12, 5/14 | 5/15, 6/1, 7/3 |
| 11 | 5/1, 5/3, 5/5, 5/7, 5/9, | 0/7, 1/9, 2/11, 3/13, 4/15, |
| | 5/11, 5/13, 5/15 | 5/1, 6/3, 7/5 |
| 12 | 6/0, 6/2, 6/4, 6/6, 6/8, | 0/9, 1/11, 2/13, 3/15, 4/1, |
| | 6/10, 6/12, 6/14 | 5/3, 6/5, 7/7 |
| 13 | 6/1, 6/3, 6/5, 6/7, 6/9, | 0/11, 1/13, 2/15, 3/1, 4/3, |
| | 6/11, 6/13, 6/15 | 5/5, 6/7, 7/9 |
| 14 | 7/0, 7/2, 7/4, 7/6, 7/8, | 0/13, 1/15, 2/1, 3/3, 4/5, |
| | 7/10, 7/12, 7/14 | 5/7, 6/9, 7/11 |
| 15 | 7/1, 7/3, 7/5, 7/7, 7/9, | 0/15, 1/1, 2/3, 3/5, 4/7, |
| | 7/11, 7/13, 7/15 | 5/9, 6/11, 7/13 |

TABLE 3
ECCE/EREG mapping with P = 8 and N = 4

| ECCE | PRB pair index/EREG index in PRB pair | |
|---|---|---|
| index | Centralized | Distributed |
| 0 | 0/0, 0/4, 0/8, 0/12 | 0/0, 2/4, 4/8, 6/12 |
| 1 | 0/1, 0/5, 0/9, 0/13 | 1/0, 3/4, 5/8, 7/12 |
| 2 | 0/2, 0/6, 0/10, 0/14 | 0/4, 2/8, 4/12, 6/0 |
| 3 | 0/3, 0/7, 0/11, 0/15 | 1/4, 3/8, 5/12, 7/0 |
| 4 | 1/0, 1/4, 1/8, 1/12 | 0/8, 2/12, 4/0, 6/4 |
| 5 | 1/1, 1/5, 1/9, 1/13 | 1/8, 3/12, 5/0, 7/4 |
| 6 | 1/2, 1/6, 1/10, 1/14 | 0/12, 2/0, 4/4, 6/8 |
| 7 | 1/3, 1/7, 1/11, 1/15 | 1/12, 3/0, 5/4, 7/8 |
| 8 | 2/0, 2/4, 2/8, 2/12 | 0/1, 2/5, 4/9, 6/13 |
| 9 | 2/1, 2/5, 2/9, 2/13 | 1/1, 3/5, 5/9, 7/13 |
| 10 | 2/2, 2/6, 2/10, 2/14 | 0/5, 2/9, 4/13, 6/1 |
| 11 | 2/3, 2/7, 2/11, 2/15 | 1/5, 3/9, 5/13, 7/1 |
| 12 | 3/0, 3/4, 3/8, 3/12 | 0/9, 2/13, 4/1, 6/5 |
| 13 | 3/1, 3/5, 3/9, 3/13 | 1/9, 3/13, 5/1, 7/5 |
| 14 | 3/2, 3/6, 3/10, 3/14 | 0/13, 2/1, 4/5, 6/9 |
| 15 | 3/3, 3/7, 3/11, 3/15 | 1/13, 3/1, 5/5, 7/9 |
| 16 | 4/0, 4/4, 4/8, 4/12 | 0/2, 2/6, 4/10, 6/14 |
| 17 | 4/1, 4/5, 4/9, 4/13 | 1/2, 3/6, 5/10, 7/14 |
| 18 | 4/2, 4/6, 4/10, 4/14 | 0/6, 2/10, 4/14, 6/2 |
| 19 | 4/3, 4/7, 4/11, 4/15 | 1/6, 3/10, 5/14, 7/2 |
| 20 | 5/0, 5/4, 5/8, 5/12 | 0/10, 2/14, 4/2, 6/6 |
| 21 | 5/1, 5/5, 5/9, 5/13 | 1/10, 3/14, 5/2, 7/6 |
| 22 | 5/2, 5/6, 5/10, 5/14 | 0/14, 2/2, 4/6, 6/10 |
| 23 | 5/3, 5/7, 5/11, 5/15 | 1/14, 3/2, 5/6, 7/10 |
| 24 | 6/0, 6/4, 6/8, 6/12 | 0/3, 2/7, 4/11, 6/15 |
| 25 | 6/1, 6/5, 6/9, 6/13 | 1/3, 3/7, 5/11, 7/15 |
| 26 | 6/2, 6/6, 6/10, 6/14 | 0/7, 2/11, 4/15, 6/3 |
| 27 | 6/3, 6/7, 6/11, 6/15 | 1/7, 3/11, 5/15, 7/3 |
| 28 | 7/0, 7/4, 7/8, 7/12 | 0/11, 2/15, 4/3, 6/7 |
| 29 | 7/1, 7/5, 7/9, 7/13 | 1/11, 3/15, 5/3, 7/7 |
| 30 | 7/2, 7/6, 7/10, 7/14 | 0/15, 2/3, 4/7, 6/11 |
| 31 | 7/3, 7/7, 7/11, 7/15 | 1/15, 3/3, 5/7, 7/11 |

TABLE 4
ECCE/EREG mapping with P = 2 and N = 4

| ECCE | PRB pair index/EREG index in PRB pair | |
|---|---|---|
| index | Centralized | Distributed |
| 0 | 0/0, 0/4, 0/8, 0/12 | 0/0, 1/4, 0/8, 1/12 |
| 1 | 0/1, 0/5, 0/9, 0/13 | 0/4, 1/8, 0/12, 1/0 |
| 2 | 0/2, 0/6, 0/10, 0/14 | 0/1, 1/5, 0/9, 1/13 |
| 3 | 0/3, 0/7, 0/11, 0/15 | 0/5, 1/9, 0/13, 1/1 |
| 4 | 1/0, 1/4, 1/8, 1/12 | 0/2, 1/6, 0/10, 1/14 |
| 5 | 1/1, 1/5, 1/9, 1/13 | 0/6, 1/10, 0/14, 1/2 |
| 6 | 1/2, 1/6, 1/10, 1/14 | 0/3, 1/7, 0/11, 1/15 |
| 7 | 1/3, 1/7, 1/11, 1/15 | 0/7, 1/11, 0/15, 1/3 |

TABLE 5
ECCE/EREG mapping with P = 2 and N = 8

| ECCE | PRB pair index/EREG index in PRB pair | |
|---|---|---|
| index | Centralized | Distributed |
| 0 | 0/0, 0/2, 0/4, 0/6, 0/8, | 0/0, 1/2, 0/4, 1/6, 0/8, |
| | 0/10, 0/12, 0/14 | 1/10, 0/12, 1/14 |
| 1 | 0/1, 0/3, 0/5, 0/7, 0/9, | 0/2, 1/4, 0/6, 1/8, 0/10, |
| | 0/11, 0/13, 0/15 | 1/12, 0/14, 1/0 |
| 2 | 1/0, 1/2, 1/4, 1/6, 1/8, | 0/1, 1/3, 0/5, 1/7, 0/9, |
| | 1/10, 1/12, 1/14 | 1/11, 0/13, 1/15 |
| 3 | 1/1, 1/3, 1/5, 1/7, 1/9, | 0/3, 1/5, 0/7, 1/9, 0/11, |
| | 1/11, 1/13, 1/15 | 1/13, 0/15, 1/1 |

TABLE 6
ECCE/EREG mapping with P = 4 and N = 8

| ECCE | PRB pair index/EREG index in PRB pair | |
|---|---|---|
| index | Centralized | Distributed |
| 0 | 0/0, 0/2, 0/4, 0/6, 0/8, | 0/0, 1/2, 2/4, 3/6, 0/8, |
| | 0/10, 0/12, 0/14 | 1/10, 2/12, 3/14 |
| 1 | 0/1, 0/3, 0/5, 0/7, 0/9, | 0/2, 1/4, 2/6, 3/8, 0/10, |
| | 0/11, 0/13, 0/15 | 1/12, 2/14, 3/0 |
| 2 | 1/0, 1/2, 1/4, 1/6, 1/8, | 0/4, 1/6, 2/8, 3/10, 0/12, |
| | 1/10, 1/12, 1/14 | 1/14, 2/0, 3/2 |
| 3 | 1/1, 1/3, 1/5, 1/7, 1/9, | 0/6, 1/8, 2/10, 3/12, 0/14, |
| | 1/11, 1/13, 1/15 | 1/0, 2/2, 3/4 |
| 4 | 2/0, 2/2, 2/4, 2/6, 2/8, | 0/1, 1/3, 2/5, 3/7, 0/9, |
| | 2/10, 2/12, 2/14 | 1/11, 2/13, 3/15 |
| 5 | 2/1, 2/3, 2/5, 2/7, 2/9, | 0/3, 1/5, 2/7, 3/9, 0/11, |
| | 2/11, 2/13, 2/15 | 1/13, 2/15, 3/1 |
| 6 | 3/0, 3/2, 3/4, 3/6, 3/8, | 0/5, 1/7, 2/9, 3/11, 0/13, |
| | 3/10, 3/12, 3/14 | 1/15, 2/1, 3/3 |
| 7 | 3/1, 3/3, 3/5, 3/7, 3/9, | 0/7, 1/9, 2/11, 3/13, 0/15, |
| | 3/11, 3/13, 3/15 | 1/1, 2/3, 3/5 |

For example, as depicted in Table 1, in the case that the centralized E-PDCCH and the distributed E-PDCCH are multiplexed on the same Physical Resource Block (PRB) pair, the use of the ECCE indexed 0 for the distributed E-PDCCH at the aggregation level 1 may block the use of the ECCEs indexed 0, 4, 8 and 12 for the centralized E-PDCCH because the EREGs to which the ECCE indexed 0 of the distributed E-PDCCH is mapped and the EREGs to which the ECCEs indexed 0, 4, 8 and 12 of the centralized E-PDCCH is mapped include the same EREGs, that is, 0/0, 1/4, 2/8 and 3/12 (the 0^{th} in the 0^{th} pair, the 4^{th} EREG in the 1^{st} PRB pair, the 8^{th} EREG in the 2^{nd} PRB pair and the 12^{th} EREG in the 3^{rd} PRB pair).

However the use of the ECCEs indexed 0 and 1 for the distributed E-PDCCH at the aggregation level 2 still blocks only the use of the ECCEs indexed 0, 4, 8 and 12 for the centralized E-PDCCH. The same applies to the aggregation level 4 without an increased number of ECCEs used for the centralized E-PDCCH.

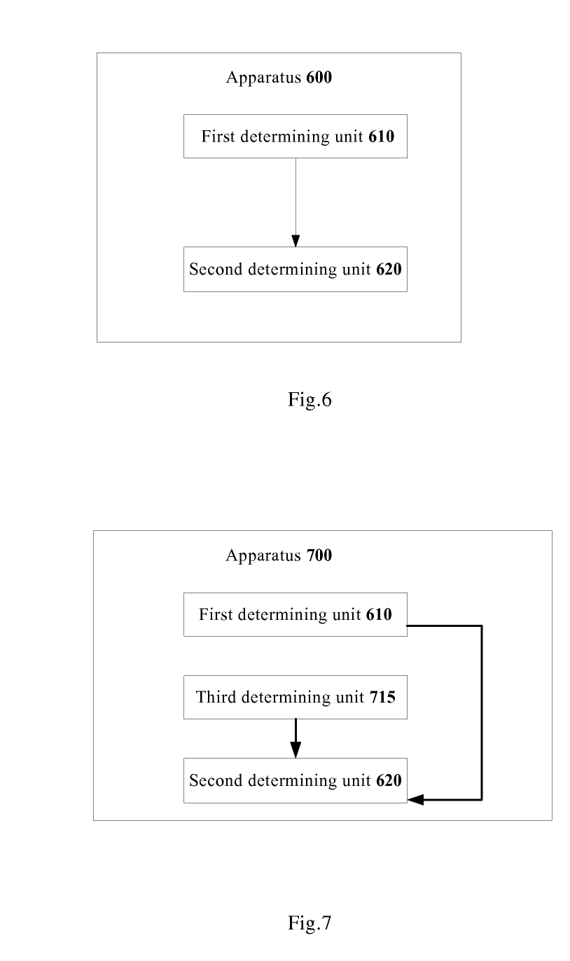

FIG. 6 illustrates a block diagram of an apparatus according to an embodiment of the invention.

As illustrated in FIG. 6, the apparatus 600 for determining a search space of an E-PDCCH of a user equipment includes a first determining unit 610 configured to determine the distance between candidates of a search space per aggregation level; and a second determining unit 620 configured to determine the position of a corresponding candidate of the search space per aggregation level in allocated ECCEs at least according to the determined distance.

The distances between respective adjacent candidates may or may not be the same. Moreover the distance between adjacent candidates may or may not be the same at different aggregation levels. Preferably the distance between respective adjacent candidates is the same, e.g., 2, at different aggregation levels, so that the candidates of the search space per aggregation level can be positioned uniformly in the allocated ECCEs.

FIG. 7 illustrates a block diagram of an apparatus according to an embodiment of the invention.

As compared with the apparatus 600 illustrated in FIG. 6, the apparatus 700 illustrated in FIG. 7 further includes a third determining unit 715 configured to determine a parameter for deciding a starting position of the candidates of the search space per aggregation level in the allocated ECCEs, and the determining unit 620 is configured to determine the position of the corresponding candidate of the search space per aggregation level in the allocated ECCEs further according to the determined parameter.

In this embodiment, the starting positions of the candidates of the search space at different aggregation levels in the allocated ECCEs may be the same.

In an embodiment, the parameter is determined in the formula of:

$${O}_{L} = ⌈ \frac{{N}_{ECCE , k}}{L \cdot {M}_{L}} ⌉ , \qquad ( 1 )$$

Where L represents an aggregation level, O_{L} represents the parameter at the L-th aggregation level, N_{ECCE, k} represents the total number of available ECCEs configured in the k-th sub-frame to be used for the user equipment, and M_{L} represents the total number of candidates of the search space at the L-th aggregation level.

Moreover in an embodiment, the distance is determined in the formula of:

$${P}_{L} = ⌊ \frac{{N}_{ECCE , k}}{L \cdot {M}_{L}} ⌋ , \qquad ( 2 )$$

Where P_{L} represents the distance between the candidates at the L-th aggregation level.

In an embodiment, the position of the corresponding candidate of the search space per aggregation level in the allocated ECCEs is determined in the formula of:

Sₖ^{(L)}=L{(Yₖ+m·P_{L}+O_{L})mod └N_{ECCE,k}/L┘}+i, i=0, 1, 2, . . . L−1, (3) and

Yₖ=(A·Yₖ₋₁)mod D, (4)

Where Sₖ^{(L)} represents the search space at the L-th aggregation level, m=0, . . . , M_{L}−1 represents a serial number across the M_{L} candidates, i represents a serial number across the ECCEs per aggregation level, Yₖ represents a hash function of the k-th sub-frame, and A and D represent constants with A=39827 and D=65537. For different frames, the hash function may be different, and various known hash functions can be adopted. Since this aspect is less relevant to the invention, a further description thereof will be omitted here for the sake of clarity.

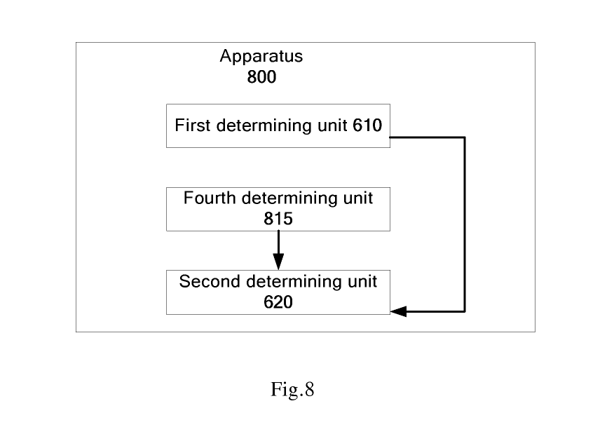

FIG. 8 illustrates a block diagram of an apparatus according to an embodiment of the invention.

As compared with the apparatus 600 illustrated in FIG. 6, the apparatus 800 illustrated in FIG. 8 further includes a fourth determining unit 815 configured to determine an anchor ECCE, where the anchor ECCE is included throughout the candidates of the search space per aggregation level; and the determining unit 620 is configured to determine the position of the corresponding candidate of the search space per aggregation level in the allocated ECCEs further according to the anchor ECCE.

In an embodiment, the position of the corresponding candidate of the search space per aggregation level in the allocated ECCEs is determined in the formula of:

$${S}_{k}^{( L )} = L \{ ( m \cdot {P}_{L} + ⌊ \frac{{I}_{ECCE , k}}{L} ⌋ ) mod ⌊ {N}_{ECCE , k} / L ⌋ \} + i , \\ i = 0 , 1 , 2 , … L - 1 , \qquad ( 5 )$$

### Where:

L represents an aggregation level, Sₖ^{(L)} represents the search space at the L-th aggregation level, m=0, . . . , M_{L}−1 represents a serial number across the M_{L} candidates, i represents a serial number across the ECCEs per aggregation level, M_{L} represents the total number of candidates of the search space at the L-th aggregation level, and N_{ECCE, k} represents the total number of available ECCEs configured in the k-th sub-frame to be used for the user equipment,

$${P}_{L} = ⌊ \frac{{N}_{ECCE , k}}{L \cdot {M}_{L}} ⌋ ,$$

represents the distance between the candidates at the L-th aggregation level,
I_{ECCE,k}=Yₖ mod(N_{ECCE,k}) represents an anchor ECCE of the k-th sub-frame, and
Yₖ=(A·Yₖ₋₁)mod D represents a hash function of the k-th sub-frame, and A and D represent constants with A=39827 and D=65537.

It shall be noted that the foregoing respective embodiments are applicable to a centralized E-PDCCH and a distributed E-PDCCH.

Moreover it shall be further noted that the position is the index of an available ECCE configured to be used for the user equipment in the foregoing respective embodiments.

Moreover the apparatus in the foregoing respective embodiments can be included in a network-side device (e.g., an eNB) or a user-side device (e.g., a UE). The foregoing various parameters can be standard-specified and further stored in the network-side device or the user-side device or can be determined by a scheduler in a practical implementation process and further received from an external device.

In an embodiment of the invention, mapping of ECCEs of a distributed E-PDCCH to EREGs satisfies at least one of the following rules:

For an aggregation level above 1, in the case of aggregating adjacent ECCEs and in the case of multiplexing a centralized E-PDCCH and the distributed E-PDCCH on the same Physical Resource Block (PRB), a ratio of collision with an ECCE in the centralized E-PDCCH is minimized; and

When there are 8 PRB pairs of the distributed E-PDCCH and 4 EREGs per ECCE of the distributed E-PDCCH, EREGs corresponding to aggregated ECCEs are on all the PRB pairs for an aggregation level above 1 and with the presence of adjacent ECCEs.

More particularly:

With P>=N, where P represents the number of PRB pairs of the distributed E-PDCCH, and N represents the number of EREGs per ECCE,

An EREG n (n=0, . . . , N−1) in an ECCE j (j=0, . . . , N_{ECCE, k-1}) is given by an EREG q in a PRB pair p represented in the equations of:

$$\begin{matrix}p = j mod ( \frac{P}{N} ) + n \cdot \frac{P}{N} , \\ and & ( 6 ) \\ q = ( ⌊ \frac{j}{P / N} ⌋ mod N + ⌊ \frac{⌊ \frac{j}{P / N} ⌋}{N} ⌋ \cdot B + n \cdot B ) mod 16 ; & ( 7 )\end{matrix}$$

and

With P<N,

An EREG n (n=0, . . . , N−1) in an ECCE j (j=0, . . . , N_{ECCE, k-1}) is given by an EREG q in a PRB pair p represented in the equations of:

p=n mod P, (8) and

$$q = ( ⌊ \frac{j}{P} ⌋ + j mod P \cdot B + n \cdot B ) mod 16 , \qquad ( 9 )$$

Where N_{ECCE, k} represents the total number of available ECCEs configured in the k-th sub-frame to be used for the user equipment, and B represents the total number of ECCEs per PRB pair.

It shall be noted that some more particular technical details well known to those skilled in the art and possibly necessary to practice the invention have been omitted in the foregoing description in order to make the invention more apparent.

Those skilled in the art shall further appreciate that the invention will not be limited to the foregoing steps, but the invention will also encompass combinations of the foregoing steps, changes in their order, etc. The scope of the invention shall be defined as in the appended claims.

Accordingly the embodiments have been chosen and described in order to better explain the principle of the invention and practical applications thereof and to make those ordinarily skilled in the art appreciate that all of modifications and variations without departing from the essence of the invention shall come into the scope of the invention as defined in the claims.

1. A method of determining a search space of an Enhanced Physical Downlink Control Channel, E-PDCCH, of a user equipment, the method comprising:
determining a distance between candidates of a search space per aggregation level; and
determining a position of a corresponding candidate of the search space per aggregation level in allocated Enhanced Control Channel Elements, ECCEs, at least according to the determined distance.

2. The method according to claim 1, wherein the method further comprises:
determining a parameter for deciding a starting position of the candidates of the search space per aggregation level in the allocated ECCEs; and
determining the position of the corresponding candidate of the search space per aggregation level in the allocated ECCEs further according to the determined parameter.

3. The method according to claim 2, wherein the parameter is determined in the formula of:
$${O}_{L} = ⌈ \frac{{N}_{ECCE , k}}{L \cdot {M}_{L}} ⌉ ,$$
wherein L represents an aggregation level, O_{L} represents the parameter at the L-th aggregation level, N_{ECCE, k} represents the total number of available ECCEs configured in the k-th sub-frame to be used for the user equipment, and M_{L} represents the total number of candidates of the search space at the L-th aggregation level.

4. The method according to claim 3, wherein the distance is determined in the formula of:
$${P}_{L} = ⌊ \frac{{N}_{ECCE , k}}{L \cdot {M}_{L}} ⌋ ,$$
wherein P_{L} represents the distance between the candidates at the L-th aggregation level.

5. The method according to claim 4, wherein the position of the corresponding candidate of the search space per aggregation level in the allocated ECCEs is determined in the formula of:
Sₖ^{(L)}=L{(Yₖ+m·P_{L}+O_{L})mod └N_{ECCE,k}/L┘}+i, i=0, 1, 2, . . . L−1, and
Yₖ=(A·Yₖ₋₁)mod D,
wherein Sₖ^{(L)} represents the search space at the L-th aggregation level, m=0, . . . , M_{L}−1 represents a serial number across the M_{L} candidates, i represents a serial number across the ECCEs per aggregation level, Yₖ represents a hash function of the k-th sub-frame, and A and D represent constants with A=39827 and D=65537.

6. The method according to claim 1, wherein the method further comprises:
determining an anchor ECCE, wherein the anchor ECCE is included throughout the candidates of the search space per aggregation level; and
determining the position of the corresponding candidate of the search space per aggregation level in the allocated ECCEs further according to the anchor ECCE.

7. The method according to claim 6, wherein the position of the corresponding candidate of the search space per aggregation level in the allocated ECCEs is determined in the formula of:
$${S}_{k}^{( L )} = L \{ ( m \cdot {P}_{L} + ⌊ \frac{{I}_{ECCE , k}}{L} ⌋ ) mod ⌊ {N}_{ECCE , k} / L ⌋ \} + i , \\ i = 0 , 1 , 2 , … L - 1 ,$$
wherein L represents an aggregation level, Sₖ^{(L)} represents the search space at the L-th aggregation level, m=0, . . . , M_{L}−1 represents a serial number across the M_{L} candidates, i represents a serial number across the ECCEs per aggregation level, M_{L} represents the total number of candidates of the search space at the L-th aggregation level, and N_{ECCE, k} represents the total number of available ECCEs configured in the k-th sub-frame to be used for the user equipment,
$${P}_{L} = ⌊ \frac{{N}_{ECCE , k}}{L \cdot {M}_{L}} ⌋ ,$$
represents the distance between the candidates at the L-th aggregation level,
I_{ECCE,k}=Yₖ mod(N_{ECCE,k}) represents an anchor ECCE of the k-th sub-frame, and
Yₖ=(A·Yₖ₋₁)mod D represents a hash function of the k-th sub-frame, and A and D represent constants with A=39827 and D=65537.

8. The method according to claim 1, wherein for a distributed E-PDCCH, mapping of ECCEs of the distributed E-PDCCH to Enhanced Resource Element Groups, EREGs, satisfies at least one of the following rules:
for an aggregation level above 1, in the case of aggregating adjacent ECCEs and in the case of multiplexing a centralized E-PDCCH and the distributed E-PDCCH on the same Physical Resource Block, PRB, a ratio of collision with an ECCE in the centralized E-PDCCH is minimized; and
when there are 8 PRB pairs of the distributed E-PDCCH and 4 EREGs per ECCE of the distributed E-PDCCH, EREGs corresponding to aggregated ECCEs are on all the PRB pairs for an aggregation level above 1.

9. The method according to claim 8, wherein:
with P>=N, wherein P represents the number of PRB pairs of the distributed E-PDCCH, and N represents the number of EREGs per ECCE,
an EREG n with n=0, . . . , N−1 in an ECCE j with j=0, . . . , N_{ECCE, k-1} is given by an EREG q in a PRB pair p represented in the equations of:
$$\begin{matrix}p = j mod ( \frac{P}{N} ) + n \cdot \frac{P}{N} , \\ and \\ q = ( ⌊ \frac{j}{P / N} ⌋ mod N + ⌊ \frac{⌊ \frac{j}{P / N} ⌋}{N} ⌋ \cdot B + n \cdot B ) mod 16 ;\end{matrix}$$
and
with P<N,
the EREG n with n=0, . . . , N−1 in the ECCE j with j=0, . . . , N_{ECCE, k-1} is given by the EREG q in the PRB pair p represented in the equations of:
p=n mod P, and
$$q = ( ⌊ \frac{j}{P} ⌋ + j mod P \cdot B + n \cdot B ) mod 16 ,$$
wherein N_{ECCE, k} represents the total number of available ECCEs configured in the k-th sub-frame to be used for the user equipment, and B represents the total number of ECCEs per PRB pair.

10. The method according to claim 1, wherein the method is performed by a network-side device or a user equipment-side device.

11. The method according to claim 1, wherein the position is an index of an available ECCE configured to be used for the user equipment.

12. An apparatus for determining a search space of an Enhanced Physical Downlink Control Channel, E-PDCCH, of a user equipment, the apparatus comprising:
a first determining unit configured to determine a distance between candidates of a search space per aggregation level; and
a second determining unit configured to determine a position of a corresponding candidate of the search space per aggregation level in allocated Enhanced Control Channel Elements, ECCEs, at least according to the determined distance.

13. The apparatus according to claim 12, wherein the apparatus further comprises:
a third determining unit configured to determine a parameter for deciding a starting position of the candidates of the search space per aggregation level in the allocated ECCEs; and
the second determining unit is configured to determine determining the position of the corresponding candidate of the search space per aggregation level in the allocated ECCEs further according to the determined parameter.

14.-16. (canceled)

17. The apparatus according to claim 12, wherein the apparatus further comprises:
a fourth determining unit configured to determine an anchor ECCE, wherein the anchor ECCE is included throughout the candidates of the search space per aggregation level; and
the second determining unit is configured to determine the position of the corresponding candidate of the search space per aggregation level in the allocated ECCEs further according to the anchor ECCE.

18. (canceled)

19. The apparatus according to claim 12, wherein for a distributed E-PDCCH, mapping of ECCEs of the distributed E-PDCCH to Enhanced Resource Element Groups, EREGs, satisfies at least one of the following rules:
for an aggregation level above 1, in the case of aggregating adjacent ECCEs and in the case of multiplexing a centralized E-PDCCH and the distributed E-PDCCH on the same Physical Resource Block, PRB, a ratio of collision with an ECCE in the centralized E-PDCCH is minimized; and
when there are 8 PRB pairs of the distributed E-PDCCH and 4 EREGs per ECCE of the distributed E-PDCCH, EREGs corresponding to aggregated ECCEs are on all the PRB pairs for an aggregation level above 1.

20.-22. (canceled)
